(19) United States
(12) Patent Application Publication
(10) Pub. No.: US 2025/0283652 A1
(43) Pub. Date: Sep. 11, 2025

(54) Portable Ice Chest Cooling Unit

(71) Applicant: Milwaukee Electric Tool Corporation, Brookfield, WI (US)

(72) Inventors: Joshua D. Adams, Milwaukee, WI (US); David J. Proeber, Milwuakee, WI (US)

(21) Appl. No.: 19/213,357

(22) Filed: May 20, 2025

Related U.S. Application Data
(63) Continuation of application No. 16/178,585, filed on Nov. 2, 2018, now abandoned.
(60) Provisional application No. 62/580,990, filed on Nov. 2, 2017.
(60) Provisional application No. 62/713,514, filed on Aug. 1, 2018.

(51) Int. Cl. F25D 19/00; F25D 1/02; F25D 3/00; F25D 3/08; F25D 11/00; F25D 17/02; F25D 17/06; F25D 23/06; F25D 29/00; G05D 23/19

(52) U.S. Cl. CPC F25D 19/003; F25D 1/02; F25D 3/08; F25D 11/003; F25D 17/06; G05D 23/1919; F25D 3/005; F25D 17/02; F25D 23/069; F25D 29/005; F25D 29/008; F25D 2400/12; F25D 2400/16; F25D 2700/12

(57) ABSTRACT

Provided herein are specifications for a cooling unit for the portable cooling of perishable goods comprising: a housing at least partially defining a compartment for holding a cooling medium; a heat exchanger; a fan positioned to generate an airflow through the heat exchanger; and an electronic control unit operable to control the fan. In some embodiments, the heat exchanger is a radiator, and the cooling unit further comprises: a cooling circuit coupled to the housing, the cooling circuit comprising an inlet in fluid communication with the compartment, a pump, an outlet in fluid communication with the compartment, the radiator and a fluid line connecting the inlet, the pump, the outlet, and the radiator; wherein the electronic control unit is further operable to control the pump and circulate cooling medium through the cooling circuit.

### CROSS REFERENCE TO RELATED APPLICATIONS

This application claims priority to co-pending U.S. provisional patent application No. 62/580,990, filed on Nov. 2, 2017, and U.S. provisional patent application No. 62/713,514 filed on Aug. 8, 2018, the entire contents of which are incorporated herein by reference.

### FIELD

The invention pertains to portable cooling systems. More specifically, the invention pertains to portable cooling units meant to fit inside a conventional portable outdoor cooler.

### BACKGROUND

Portable coolers are used to reduce heat transfer between the surrounding environment and the contents of the portable cooler. They are often made from a hard-plastic shell filled with foam insulation within and used to keep perishable goods at lower temperature to prevent spoilage. Current passive coolers do not maintain a constant temperature throughout the enclosure of the cooler. Instead passive coolers have a temperature gradient between the ice or ice water mixture, which naturally rests at the bottom of the cooler, and the top. Current coolers also have the drawback of needing to place the perishable goods in direct contact with the ice. As the ice melts into water it can seep into some food products and ruin them or cause cross contamination.

### SUMMARY

Provided herein are specifications for a cooling unit for the portable cooling of perishable goods comprising: a housing at least partially defining a compartment for holding a cooling medium; a heat exchanger; a fan positioned to generate an airflow through the heat exchanger; and an electronic control unit operable to control the fan. In some embodiments, the heat exchanger is a heat sink that is coupled to the housing and positioned to be in thermal communication with the cooling medium held in the compartment. In some embodiments, the electronic control unit further comprises one or more sensors inside the compartment, wherein the sensor or sensors are in electrical communication with the electronic control unit. In some embodiments, the electronic control unit further comprises one or more sensors outside the compartment, wherein the one or more sensors are in electrical communication with the electronic control unit. In some embodiments, the electronic control unit further comprises an electrical power source. In some embodiments, the electronic control unit is configured to wirelessly communicate with a personal mobile device. In some embodiments, the electronic control unit further comprises a speaker. In some embodiments, the electronic control unit further comprises an electronic display and/or buttons to allow for user control.

In some embodiments, the cooling unit further comprises a movable lid coupled to the housing. In some embodiments, the compartment is insulated using an evacuated chamber, a foam insulation, or air. In some embodiments, the housing includes snaps, clamps, screws, ties, adhesives, pins, tracks or arms to secure it to another surface. In some embodiments, the cooling unit further comprises a drain coupled to the housing and in fluid communication with the compartment. In some embodiments, the cooling unit further comprises a handle coupled to the housing. In some embodiments, the cooling unit has been sized and configured to fit within a conventional portable outdoor cooler.

In some embodiments, the heat exchanger is a radiator, and the cooling unit further comprises: a cooling circuit coupled to the housing, the cooling circuit comprising an inlet in fluid communication with the compartment, a pump, an outlet in fluid communication with the compartment, the radiator and a fluid line connecting the inlet, the pump, the outlet, and the radiator; wherein the electronic control unit is further operable to control the pump and circulate cooling medium through the cooling circuit. In some embodiments, the electronic control unit further comprises one or more sensors associated with the fluid line.

In some embodiments, the housing further at least partially defines a product compartment and the heat exchanger is positioned inside the product compartment. In some embodiments, the product compartment is insulated using an evacuated chamber, a foam insulation, or air. In some embodiments, the barrier can be repositioned to change the relative sizes of the compartment and product compartment inside the housing. In some embodiments, wherein the compartment is detachable from the housing.

In some embodiments, a method of cooling a product in a portable ice chest includes locating a cooling unit within an interior volume of the portable ice chest. The cooling unit comprises a housing at least partially defining a compartment for holding a cooling medium. A cooling medium located in the cooling unit is pumped from the housing through a radiator. An airflow is generated across the radiator. The airflow is directed through an outlet of the cooling unit and into the portable ice chest. In some embodiments air is provided from the portable ice chest into the cooling unit via an air inlet and the air provided through the air inlet is the airflow moved across the radiator.

### BRIEF DESCRIPTION OF THE DRAWINGS

FIG. 1 depicts an external view of a first embodiment of a cooling unit with the lid in the open position, depicting several of the exterior elements.

FIG. 2 depicts a top view of the cooling unit of FIG. 1 with the lid opened and depicts the elements inside the insulated compartment.

FIG. 3 depicts the cooling unit of FIG. 1 with a section of the external housing removed so as to view some of the internal cooling circuit elements.

FIG. 4 illustrates a schematic electronic control unit.

FIG. 5 illustrates a schematic depiction of the cooling circuit in operation.

FIG. 6 depicts a cross sectional view of the cooling unit of FIG. 1 positioned inside a conventional portable cooler.

FIG. 7A depicts an external view of a second embodiment of the cooling unit.

FIG. 7B depicts a cross-sectional view of the cooling unit of FIG. 7A.

FIG. 8A shows an underside view of the cooling unit of FIG. 7A, and how air flows through the cooling unit

FIG. 8B shows an underside view of the cooling unit of FIG. 7A with a section of the housing removed.

FIG. 9 is a schematic visualization of the possible use steps to operate the cooling units.

FIG. 10 depicts a third embodiment of a cooling unit.

FIG. 11 depicts a schematic, cross-sectional representation of the cooling unit of FIG. 10.

### DETAILED DESCRIPTION

The present invention is not limited in its application to the details of construction and the arrangement of the components set forth in the following description or illustrated in the following drawings. The invention is capable of other embodiments and of being practiced or of being carried out in various ways.

The present invention can be used in conjunction with a conventional portable cooler to be used during camping, while tailgating, or otherwise away from traditional power sources, where it is able to provide a weekend of cooling with only a single bag of ice and a single portable power bank. In the present invention, ice and liquid remain separated from the perishable food while the cooling technology circulates cool, arid air for uniform cooling. As a result, moisture is kept away so the contents in the cooler, allowing them to remain in the same condition as when they were placed in cooler.

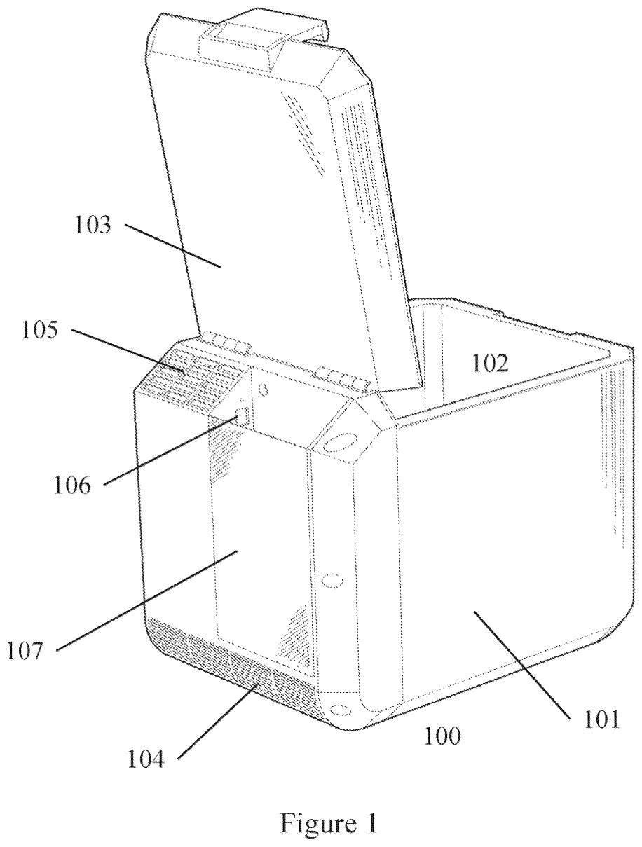

FIG. 1 depicts an exterior view of a first embodiment of a cooling unit 100. The housing 101 may be made from injection molded plastic or other suitable materials, including resin, metals, and plastics, or other suitable manufacturing methods. The figure also depicts the insulated compartment 102 which is meant to hold a cooling medium. The cooling medium may be a liquid, such as water or other liquid having a thermal heat capacity, or a combination of a liquid and a solid, such as ice and water or frozen glycol packs and water. Suitably the cooling medium may include other material capable of absorbing heat. The cooling unit 100 may comprise a lid 103, optionally attached to the housing 101 using two hinges and affixed using screws but could be attached using other fixtures (e.g. snaps, rivets, pins, etc.) or adhesives. The lid 103 may be held closed using a clasp in this embodiment, but other methods could be used to secure the lid (e.g. ties, latches, screw downs, etc.). The compartment 102 and lid 103 may be insulated using foam insulation, but other insulation methods and materials could be used (e.g. fibrous insolation, evacuated chamber, multi-layer plastic with an outer casing, etc.), or a gas (e.g. helium, air etc.). Such an arrangement not only maintains the cold temperature within the cooling unit, but also prevents moisture from condensing on the exterior of the cooling unit 100, thereby limiting or eliminating the water from collecting on the exterior of the cooling unit and depositing in the conventional portable cooler. Alternatively, the lid 103 and housing 101 can have no insolation or be made of a single layer of plastic. The insulated compartment 102 would also be water tight to prevent the cooling medium from leaking outside the insulated compartment.

The cooling unit 100 also includes an air inlet 104 on the bottom of the housing 101 where warm air would enter and an air outlet 105 at the top where the cooled air would exit. An external USB port 106 is also pictured where a portable power source could be attached to provide power to an electronic control unit. In the present embodiment, the power source may take the form of a standard USB lithium ion battery pack and is provided a pocket 107 to rest inside. The battery pack could also be held in place by other means (e.g. ties, netting, clasps etc.). By making it detachable, the user can easily switch a drained battery pack out with a fully charged one. This would minimize the down time of the cooling unit 100 and allow for longer continuous operation. The USB port 106 could also be used to pass data to and from the electronic control unit and an external communication device such as a mobile phone.

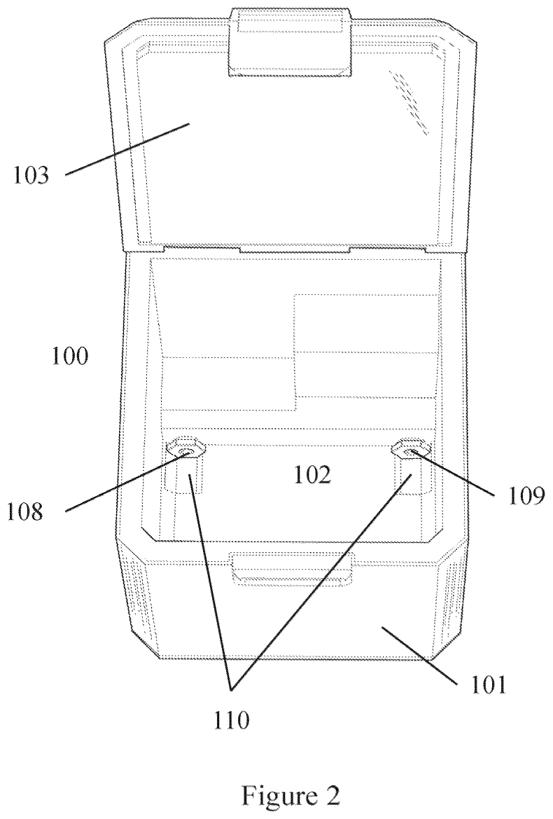

FIG. 2 provides a top view of the cooling unit 100 with the lid 103 opened and into the insulated compartment 102 within the housing 101. Here an internal inlet 108 and outlet 109 are pictured. They are both positioned on the bottom of the insulated compartment 102 surrounded by a divot 110 to allow the cooling medium to more easily collect and reduce the amount of air entering the system. These positions are not the only possible positions of the inlet 108 and outlet 109 and could be positioned anywhere within the insulated compartment 102, whether associated with the bottom or a sidewall of the insulated compartment 102. In some embodiments, the outlet 109 may be positioned near the top of the insulated compartment 102 to better facilitate a more efficient circulation of the cooling medium.

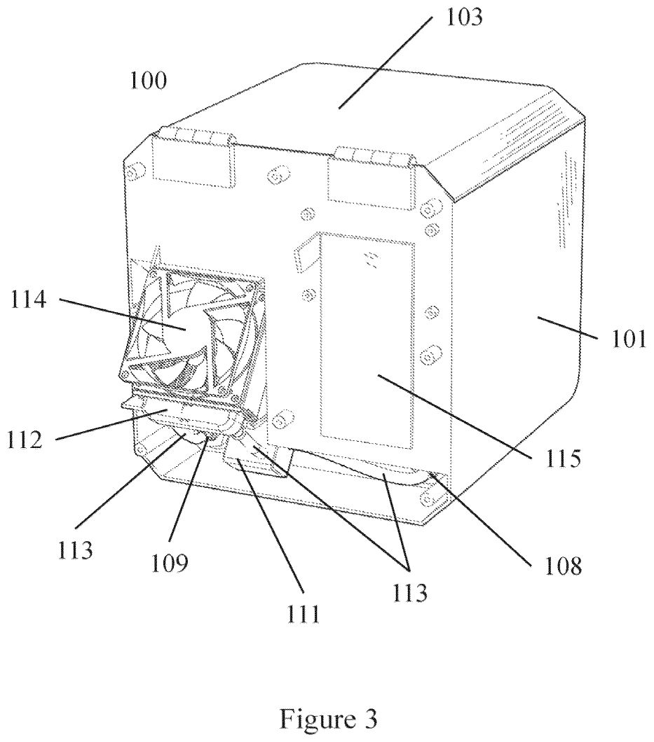

FIG. 3 depicts the cooling unit 100 with the lid 103 closed and a section of the external housing 101 removed so as to view some of the internal cooling circuit elements. The cooling circuit is constructed by connecting the water inlet 108 of the insulated compartment, the pump 111, the radiator 112 and the water outlet 109 of the insulated compartment with a fluid line 113. The fluid line could be a soft tubing (e.g. silicone, rubber, nylon, etc.) or it could be rigid tubing (e.g. copper, PVC, acrylic, etc.). These lengths of the fluid line 113 may be attached to the individual components of the cooling circuit using common fixtures (e.g. barbs and gaskets, tube clamps, adhesives etc.). The cooling circuit may also include a tee junction which may be positioned at the lowest point of the cooling circuit. A bleed line may be attached to the tee to selectively allow draining of the residual cooling medium from within the cooling circuit to prevent corrosion or mold build up. During normal operation the tee junction, if present, would be sealed, for example, with a plug or cap, or valve. The fan 114 is positioned to force air through the radiator 112. The electronic control unit 115 may be used to control the speed of the fan 114 and/or the flow rate generated by the pomp 111. The electronic control unit 115 may also be used for a multitude of other purposes as described below.

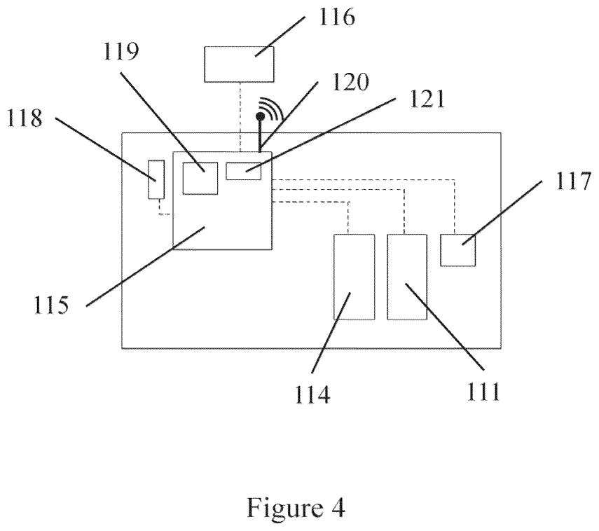

FIG. 4 is a schematic of an electronic control unit 115. This electronic control unit 115 draws power from the electric power source 116 (e.g. battery back, solar panel, AC outlet, standard 12V car battery etc.) and uses it to power and control the various electrical components that are included in the many embodiments of the present invention. When powered by an external power source 116, the power cable can extend through a preexisting drain hole found in most conventional portable coolers. A tapered plug can extend around the power cable to make the drain hole watertight. In some embodiments the electronic control unit 115 would interface with one or more sensors. The one or more sensors may include internal sensors 117 located inside the insulated compartment to monitor, for example, temperature, humidity, and/or fill level; external sensors 118 located outside the cooling unit to monitor, for example, ambient temperature and/or humidity; or system sensors associated with the cooling circuit to monitor, for example, flow rate and/or temperature of the cooling medium. The one or more sensors may be making continuous measurements or periodic measurements. The electronic control unit 115 would then use those inputs as well as performance targets (e.g. desired temperature, run time, etc.) given to it by the user to determine how to best operate the pump 111 and radiator 112. It could also be used to give a warning to the user to alert him or her when the power source 116 or cooling medium needs to be replaced. It could also be used to alert the user to when there is a possible leak in the insulated compartment or when the lid is not closed using a light sensor or an electric switch. It could also be programed to shut off the cooling unit when the lid is in its open position or has been left open for a set period of time to conserve energy. In other embodiments the electronic control unit 115 could interface with an electronic display 119 affixed to the outside of the housing and visible to the user. Allowing the user to operate the cooling unit without the need to open the conventional portable cooler. This could be used to communicate information to the user and used in combination with a single button or a number of buttons to receive inputs from the user and a speaker 121 to audibly convey information to the user.

The electronic control unit 115 may also include a wireless protocol module 120 (e.g. Bluetooth, IEEE 802.11, infrared, etc.) to interface with a mobile device (e.g. mobile phone, smart watch, tablet, computer, etc.) or an accompanying wireless device. This would allow the user to control and monitor aspects of the cooling unit through the use of an accompanying software program. For example, a user can view the current temperature and humidity level within the cooling unit and within the conventional portable cooler. Further still, the accompanying software can provide temperature recommendations or automatically implement preselected temperatures based on user inputs indicating the product located within the cooler. These products could include anything responds to changes in temperature. This generally is perishable food items, such as meat products or fruits and vegetables, or other products are not perishable, but are better enjoyed at lower than ambient temperatures, such as beer or soda. The product however is not limited to food, it could also be used to cool medical products such as medicines, vaccines or even organ transplants. For example, different types of wines can be inputted to the software and, in response, the mobile device can provide a wireless signal to the electronic control unit 115 of the cooling unit to adjust the temperature to appropriately cool the inputted type of wine. Further, different products such as foods, medical devices, transplants or vaccines can be preprogrammed into the accompanying software with associated desired temperatures. These temperatures can be relayed to the electronic control unit 115 of the cooling unit when the user inputs the product type. The software can also remember the most commonly used and/or the most recently used presets.

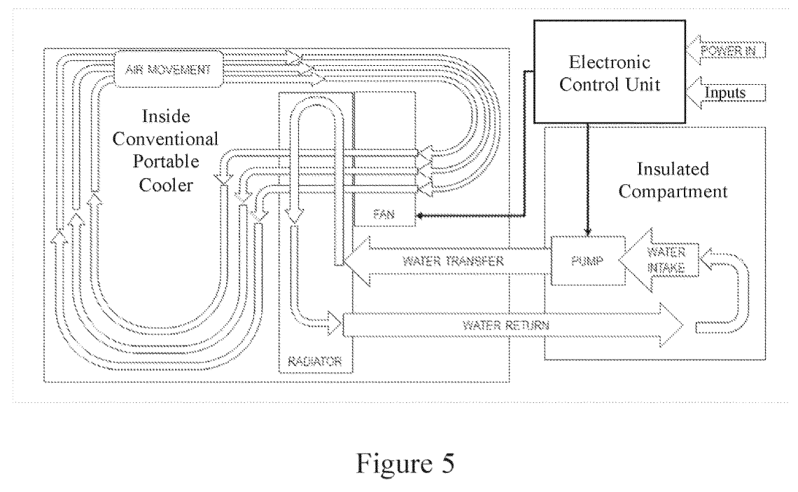

FIG. 5 is a schematic depiction of the cooling circuit in operation after the user places the cooling unit inside a conventional portable cooler and fills the insulated compartment with a cooling medium (e.g. water and ice). The user places a product (e.g. food, beverages, or medical products) into the cooler so that the air outlet of the cooling unit is facing it. A desired temperature is set via the input of the electronic control unit. The electronic control unit then provides a signal to the pump to move fluid from the insulated compartment into the cooling circuit through the inlet. The cooling medium within the fluid line then moves through the radiator and back to the insulated compartment via the outlet. The electronic control unit provides a signal to the fan to draw air in from the air inlet. The fan further provides an airflow through the radiator and out the air outlet. Heat transfer cools the airflow from the fan as the airflow passes through the radiator. Therefore, the temperature of the airflow from the air outlet is cooler than the temperature entering the air inlets. This cycle repeats and produces an overall decrease of temperature of the environment outside of the cooling unit, but within the conventional portable cooler.

Once the desired temperature is attained within the cooler based on the continuous heat transfer between the cooling medium of the insulated compartment and the air surrounding the cooling unit, the pump and fan are shut off by the electronic control unit. If the temperature rises above a specified threshold (e.g., two degrees above the desired temperature, five degrees above the desired temperature, etc.) the fan and the pump are reactivated to provide additional heat transfer to decrease the temperature of the interior of the cooler back to the desired temperature. Alternatively, the fan speed and flow rate of the pump may run continuously but vary in speed and flow rate respectively as to actively maintain the desired temperature.

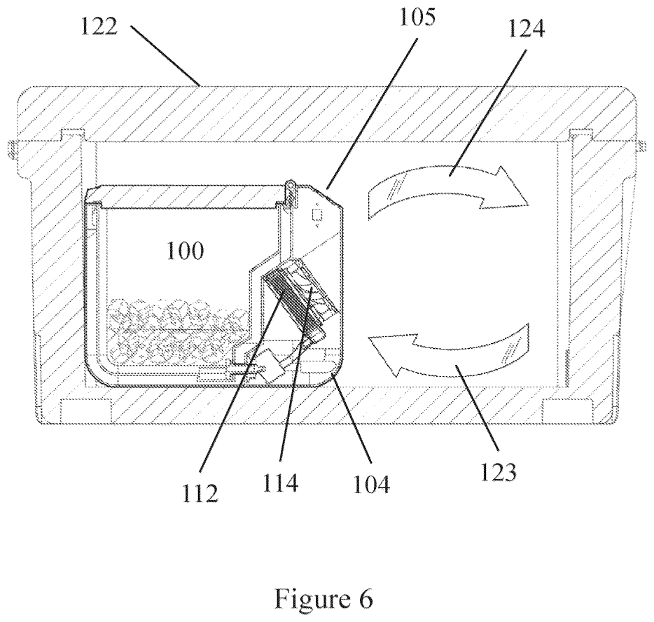

FIG. 6 depicts the cooling unit 100 positioned inside a conventional portable cooler 122. Here the cooling unit 100 is positioned so that the air inlet 104 would gather warmer air 123 from the bottom of the conventional portable cooler by the fan 114. Then the warmer air 123 would then pass through the radiator 112 and back out through the air outlet 105 as cooler air 124. In some embodiments the cooling unit 100 would include arms that mount on tray ledges within the conventional portable cooler 122. The arms can extend to grab coolers of various widths. The cooling unit 100 could also be held in place using other means (e.g. ties, tracks, clamps etc.).

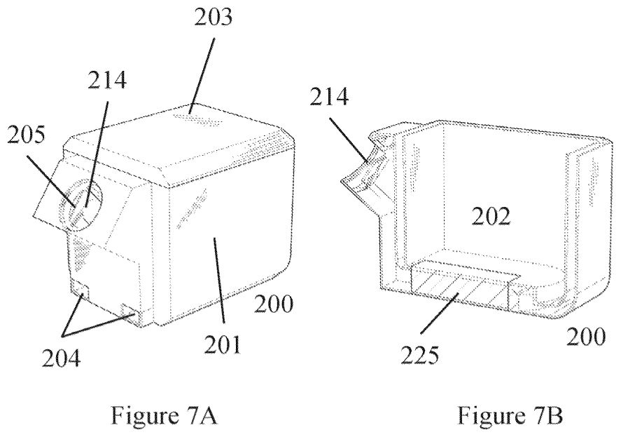

FIGS. 7A and 7B illustrates an assembly 200 in accordance with a further embodiment of the invention. Many of the labeled components are the same or serve the same function as components in the earlier embodiment and share the same reference number. For example, the fan of the first embodiment is labeled “114,” and the fan of the second embodiment is labeled “214.” This numbering scheme is for convenience used throughput this specification.

The largest difference between this embodiment and the last is that a heat sink 225 is placed in thermal communication with the cooling medium of the insulated compartment 202 directly, with fins on the external side. The insulated compartment 202 is filled with a cooling medium and the cooling unit 200 may be placed within a conventional portable cooler adjacent to the products intended to be cooled or maintained at a cold temperature. Advantageously, this embodiment may only have a single electrical component, the fan 214, thereby taking advantage of a decreased power draw. Further, the cooling medium is sealed and insolated relative to the other contents of the conventional portable cooler such that the heat transfer is primarily mediated via the heat sink 225.

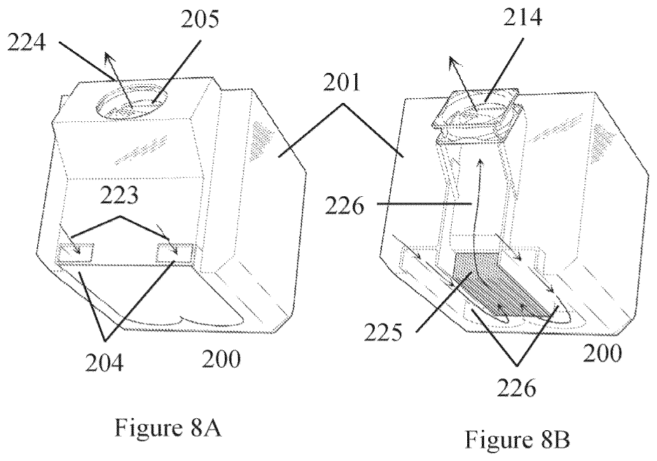

FIGS. 8A and 8B shows external views of the cooling unit 200 from the underside, with and without the entirety of the housing 201. As shown in FIG. 8A, the cooling unit 200 has an air outlet 208 located near the top of the cooling unit 200 and an air inlet 204 located near the bottom. FIG. 8B shows the internal components, and how air (as indicated by the arrows) is drawn through the cooling unit 200. Ambient air 223 is drawn into the cooling unit by fan 214 through the air inlet 204. It then flows through channels 226 where it makes contact with the heat exchanger 225. The air passes through the vertical fins of the heat exchanger 225 and continues to flow through the channels and finally exits the cooling unit 200 through the air outlet 205. The channels 226 may take many different forms and may be molded into the housing 201, as shown, or be separately installed components. By the ambient air 223 making contact with the heat exchanger 225, heat is passed from the air to the cooling medium, cooling the air before being expelled via the outlet 205 as cooled air 224.

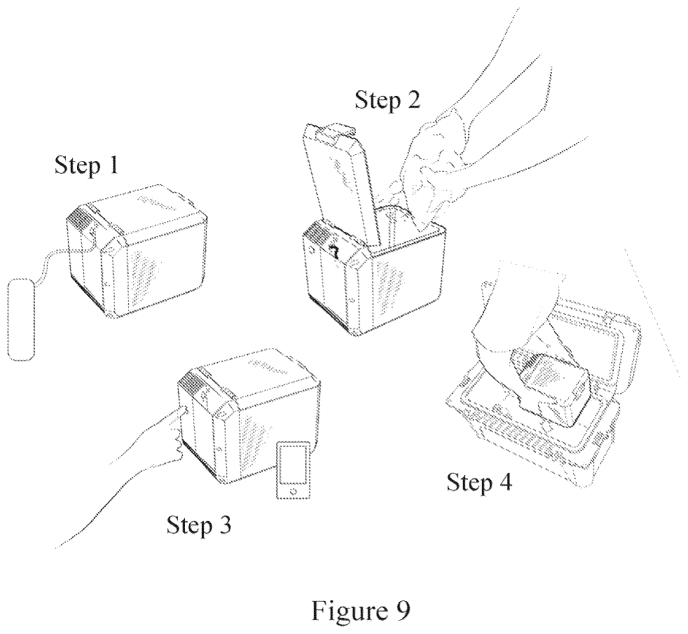

FIG. 9 is a schematic visualization of the possible use steps to operate the cooling units. In a first step, a power source is plugged into the cooling unit via the USB port. In other embodiments, the power source may be an internal rechargeable battery that remains plugged into the cooling unit. In a second step, the cooling unit is primed by lifting the lid off the insulated compartment and filling the compartment with cooling medium to cover the bottom of the compartment. A third step requires the user to turn the cooling unit on. In some embodiments, the cooling unit may be turned on by actuating a button, switch, or other actuator on the cooling unit, by providing an input to the personal mobile device. In other embodiments, the cooling unit may be turned on by adding the cooling medium or opening the lid, or based on a sensor input, such as an optical sensor or a temperature sensor. In this particular embodiment this is achieved by pressing a button on the exterior of the cooling unit. The cooling unit may retain the last desired values inputted into the control unit such that powering on the cooling unit provides the most recent user input values (e.g., temperature). In other embodiments, the user may be able to preprogram the desired user input values prior to turning on the unit. Lastly, the cooling unit is placed into any conventional portable cooler, positioned so that the air outlet is facing the products to be cooled. The unit pulls air from the cooler, chills the air, and returns the air to the cooler to maintain the temperature within the cooler at a preset temperature while keeping the products clear of condensation from the ice/water in the in-cooler unit. Although the steps are numbered for convenience, those of skill in the art will recognize that the steps may be performed in any suitable order.

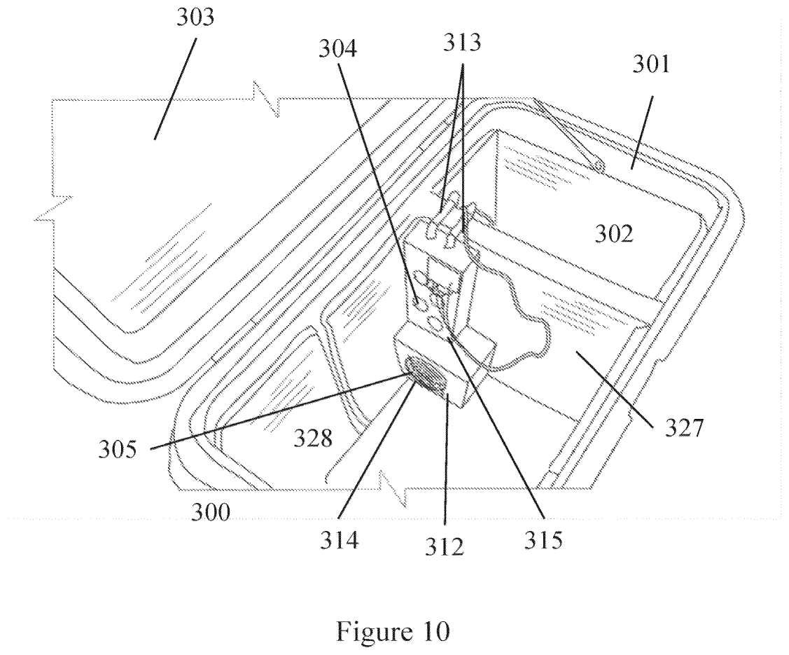

FIG. 10 illustrates an assembly 300 in accordance with a third embodiment of the present invention. Many of the labeled components are the same or serve the same function as components in the earlier embodiments and share the same reference number. For example, the fan of the first embodiment is labeled “114,” and the fan of the third embodiment is labeled “314.” This numbering scheme is for convenience used throughput the specification.

In this embodiment the cooling unit 300 is integrated with a portable cooler. This is where the housing 301 is divided into two separate compartments using a barrier 327 and have a lid 303 that partially defines both compartments or alternatively, they each have their own lid that partially defines each compartment independently. The lids would be attached in similar manner described in earlier embodiments and will be capable of transitioning from an open to a closed position. The first compartment 302 contains the cooling medium. The product compartment 328 contains the products to be cooled or maintained at a cooler than ambient temperature. These products could include anything that responds to changes in temperature. This generally is perishable food items, such as meat products or fruits and vegetables, or other products that are not perishable, but are better enjoyed at lower than ambient temperatures, such as beer or soda. The products however are not limited to food, it could also be used to cool medical products such as medicines, vaccines or even organ transplants. Both compartments may be insulated using the methods described in the previous embodiments. Much of the cooling circuit described in earlier embodiments is attached and/or incorporated into the insulated barrier 327 that separates the two compartments. This includes the pump, the radiator 312, the fan 314, the fluid lines 313, as well as the water inlet and the water outlet. This embodiment 300 also could include the same electrical control unit 315 described in the previous embodiments. In some embodiments, the cooling circuit components are solely attached and/or incorporated into the barrier 327. This would allow the barrier 327 to be moveable within the housing 301 through a series of slots or other fixtures (e.g. clamps, snaps, locks etc.), allowing the user to change the relative sizes of the two compartments so that more room can be afforded to the cooling medium for more cooling potential or to the product compartment to accommodate more perishable goods. The cooling circuit is also not limited to be attached and/or incorporated into the moveable barrier. The cooling circuit could instead be attached and/or incorporated into other parts of the housing 301 such as the compartment walls or even the lid 303.

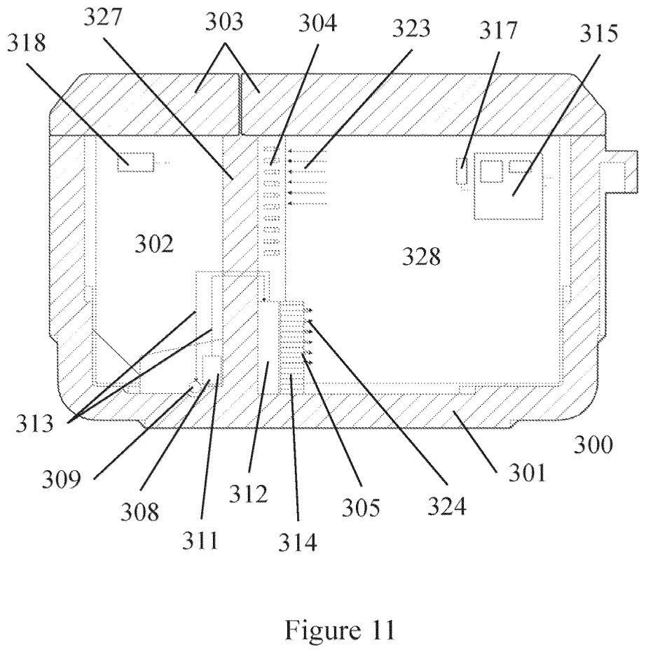

FIG. 11 shows in cross section an exemplary arrangement of the various components of the cooling unit and circuit. The pump 311 is positioned within compartment 302. The pump 311 is operable to draw the cooling medium from the compartment 302 into the water inlet 308. The inlet 308 could take many forms such as a plurality of plastic tubes attached via L-brackets to pass around the partition wall, or as holes directly incorporated into the barrier. In another embodiment, the pump 311 may also be located in the product compartment 328 to draw fluid into the inlet. A cooling circuit comprises the radiator 312, the pump 311, a water inlet 308 and a water outlet 309. A fan 314 to produces an airflow 324 over the radiator 312 and draws air in via the inlet 304 and expels air via the outlet 305. The air outlet 305 is positioned near the bottom of the product compartment 328, and the inlet 304 is positioned near the top, both may be covered with a mesh or grate to prevent products from interfering with the airflow 324 or the fan 314.

The radiator 312 is used as a heat exchanger to transfer thermal energy between the cooling medium in cooling circuit and the air being drawn through the system. The radiator 312 is optionally positioned adjacent to the fan 314. The fan 314 is positioned adjacent to the air outlet 305 and operates to move the air from the air inlet 304 through the radiator 312. Fluid in the radiator 312 that has been warmed by the airflow 324 passes through the radiator 312 and to the outlet 309. In another embodiment, the fluid lines 313 could instead pass through an aperture instead of over the barrier 327. This would be sized and sealed to prevent airflow and fluid flow therethrough, except for the fluid passing through the fluid lines 313. In other embodiments, a baffle may be positioned within the product compartment 328 to direct the airflow 324 of the air outlet 305 throughout the product compartment 328. This is to decrease the possibility of a product within the product compartment 328 from obstructing the air outlet 305 and dissipates the cooled air more evenly throughout the product compartment 328. In some embodiments the baffle extends from the air outlet 305 along the length of the product compartment 328 and includes a plurality of air outlets spaced along the length of the baffle. The baffle may be positioned along the bottom of the product compartment 328 or may be located adjacent a wall or centrally within the compartment 328 with air outlets on one or more sides.

Also, in other embodiments a depression is formed in the bottom of the product compartment 328, located adjacent to the barrier 327. The depression allows condensation created as a result of the cooling components being at a lower temperature than the dew point of the air within the product compartment 328 to gather in a controlled wet area and remain isolated from the products within the product compartment 328. The collected condensation may be directed to a drain hole or a weep hole located in the product compartment 328 to allow for continuous or periodic draining. For periodic draining, a stopper, plug, cap, or other suitable device may be used to control draining. Such devices may be located in a position on the exterior of the cooling unit 300, to allow a user to access or manipulate the device without the need to open the lid 303 of the product compartment 328. The first compartment 302 may also include a drain hole or a weep bole positioned at or near the lowest point of the compartment 302. The drain hole or weep hole of the first compartment 302 may allow a user to selectively drain cooling medium liquid from the first compartment 302 and may be sealed with a stopper, plug, cap, or other suitable device accessible from inside the first compartment 302 or the exterior of the cooling unit 300.

1.-20. (canceled)

21. A portable cooler comprising:
a housing comprising:
a first compartment; and
a second compartment;
a barrier separating the first compartment and the second compartment;
a cooling circuit incorporated into the barrier, the cooling circuit comprising a fan positioned along a bottom surface of the second compartment;
an electronic control unit operable to control the fan; and
a lid coupled to a top of the housing, the lid defining an upper surface the first compartment and the second compartment.

22. The portable cooler of claim 21, wherein the barrier is an insulated barrier.

23. The portable cooler of claim 21, wherein the lid comprises:
a first lid configured to enclose the first compartment; and
a second lid configured to enclose the second compartment.

24. The portable cooler of claim 21, further comprising an air inlet positioned within the second compartment and an air outlet positioned adjacent to the fan.

25. The portable cooler of claim 24, wherein the fan is configured to move warm air into the air inlet through the cooling circuit and to move cool air out though the air outlet.

26. The portable cooler of claim 24, wherein the air inlet is positioned adjacent to the top of the housing and wherein the air outlet is positioned adjacent to the bottom surface of the second compartment.

27. The portable cooler of claim 21, further comprising one or more sensors positioned within the second compartment, the one or more sensors are in electrical communication with the electronic control unit.

28. The portable cooler of claim 27, wherein the one or more sensors are configured to take measurements of an input in the second compartment and use the input and a performance target to determine operation of the cooling circuit.

29. The portable cooler of claim 28, wherein the input is temperature of the second compartment and the performance target is a target temperature.

30. A portable cooler comprising:
a housing comprising:
a first compartment; and
a second compartment;
a thermal barrier separating the first compartment and the second compartment;
a fan positioned in the second compartment;
an electronic control unit operable to control the fan; and
a lid coupled to a top of the housing, the lid located above the first compartment and the second compartment.

31. The portable cooler of claim 30, wherein the fan is positioned along a bottom surface of the housing.

32. The portable cooler of claim 31, further comprising an air inlet and an air outlet, wherein the air inlet is positioned adjacent to the top of the housing and the air outlet is positioned adjacent to the bottom surface of the housing.

33. The portable cooler of claim 30, wherein the lid comprises:
a first lid that defines the first compartment; and
a second lid that defines the second compartment.

34. The portable cooler of claim 30, wherein the lid is attached to the housing via a hinge, and wherein the lid is moveable between an open position and a closed position in which the first compartment and the second compartment are enclosed.

35. The portable cooler of claim 30, further comprising a cooling circuit, the cooling circuit comprising:
a fluid inlet in communication with the first compartment;
a pump; and
a fluid outlet in communication with the first compartment;
one or more fluid lines connecting the fluid inlet, the pump, and the fluid outlet.

36. A portable cooler comprising:
a housing comprising:
a first compartment; and
a second compartment;
a barrier separating the first compartment and the second compartment;
a fan positioned in the housing and attached to the barrier;
an electronic control unit operable to control the fan; and
a lid coupled to a top of the housing, the lid comprising:
a first portion that covers the first compartment; and
a second portion that covers the second compartment.

37. The portable cooler of claim 36, further comprising an air inlet positioned within the second compartment and an air outlet positioned adjacent to the fan.

38. The portable cooler of claim 36, further comprising a pump attached to the barrier, the pump configured to draw a cooling medium from a bottom surface of the housing.

39. The portable cooler of claim 38, wherein the pump is positioned in the second compartment.

40. The portable cooler of claim 38, wherein the cooling medium is water.
